(19) United States
(12) Patent Application Publication
(10) Pub. No.: US 2024/0416999 A1
(43) Pub. Date: Dec. 19, 2024

(54) FRAME DESIGN FOR ENCLOSED CARGO TRAILER STRUCTURES

(71) Applicant: Charles Morgan Daugherty, Cleveland, GA (US)

(72) Inventor: Charles Morgan Daugherty, Cleveland, GA (US)

(21) Appl. No.: 18/731,609

(22) Filed: Jun. 3, 2024

Related U.S. Application Data
(60) Provisional application No. 63/508,110, filed on Jun. 14, 2023.

(51) Int. Cl. B62D 21/20; B60R 16/02

(52) U.S. Cl. CPC B62D 21/20; B60R 16/02

(57) ABSTRACT

The present invention provides a frame design for enclosed cargo trailer structures utilized as mobile commercial enterprises to protect base electrical wiring throughout the walls and ceiling of the structure, support for a mechanical wall set back or offset from the exterior walls of the structure, wherein the electrical wiring flows to and from the mechanical wall, ensures proper placement and securement of a fuel tank and gas lines along the underside of the base of the structure.

### CROSS-REFERENCE TO RELATED APPLICATION

This application claims the benefit of priority of U.S. provisional application No. 63/508,110, filed Jun. 14, 2023, the contents of which are herein incorporated by reference.

### BACKGROUND OF THE INVENTION

The present invention relates to building frames and, more particularly, to a frame design for enclosed cargo trailer structures.

Throughout the last century, building codes have been updated to protect the life, health, and safety of the public. These have included regulations regarding electrical systems, gas systems, plumbing systems, and fire safety, among many other areas. In the construction world, MEP stands for “mechanical, electrical and plumbing”, wherein MEP engineering is the science and art of planning, designing, and managing the MEP systems of a building so that these systems are up to code.

At the same time, traditional brick and mortar buildings have proven disadvantageously costly and commitment-intensive for many businesses, and so smaller mobile commercial structures have risen in popularity, one of the most salient examples is the seemingly ubiquitous “food truck”. There are other names for such mobile stores, such as “food trailer”, and the like. Regardless of the name, many of these large, motorized vehicles are retrofitted enclosed cargo trailers equipped to store, transport, prepare, serve, and/or sell food or other goods.

In the last several decades enclosed cargo trailers have been retrofitted into food trucks as well as mobile offices, mobile bookstores, mobile arcades, mobile pet groomers, and many other commercial purposes. To allow businesses to operate on these mobile platforms, electrical systems, liquefied petroleum (“LP”) gas systems, and plumbing systems, among other systems, have been installed in the confined space afforded by these enclosed cargo trailer structures.

The installations of MEP systems within enclosed cargo trailer structures, known as “up-fittings” in the industry are, however, typically done with no regard to building codes. This puts these businesses on the wrong side of the law and unnecessarily increases safety risks for the public and the business employees.

As can be seen, there is a need for a frame design for enclosed cargo trailer structures that enables installation of various MEP systems that meet building code requirements. Furthermore, the frame design of the present invention would increase the structural integrity and stability of cargo trailers, which were not originally designed for use as mobile commercial enterprises. Colloquially, the present invention is known as the Mobile Kitchen Shell (MKS).

### SUMMARY OF THE INVENTION

The present invention provides a frame design for enclosed cargo trailer structures utilized as mobile commercial enterprises to protect base electrical wiring throughout the structure. The electrical system embodied by the present invention enables base electrical wiring to be installed with proper minimum distancing from exterior and interior spaces. Ensuring this minimum distancing prevents wiring from becoming tangled as the wiring transverses from the main power line (e.g., shoreline and a motor base plug) to the high voltage panel and up one or more vertical walls of the enclosed trailer and throughout the ceiling for powering a myriad of equipment.

The present invention provides a frame design that also provides support for a mechanical wall set back or offset from the exterior walls. The mechanical wall may support and protect an electrical panel and other electrical interfaces so that they meet the minimum clearance requirements for each MEP system according to the required codes. This “offset” wall can be integrated into the front, sides walls or back of the unit depending upon the required use.

The present invention also provides proper securement and protection for high voltage and low voltage wires that extend within the vertical wall(s) as well as through the ceiling of the enclosed trailer by way of joists that provide proper (e.g., at least one and one-half inch clearance on all sides) clearance between adjacent high voltage wires as well as proper spacing of the set of wiring from an exterior space (of a wall/ceiling that houses the wiring) and the interior space of the enclosed trailer.

As for the MEP gas systemic components, the present invention further ensures proper placement and securement of both a portable style and permanent mount generator, fuel tank, LP-Gas tanks with a proper protective cage and, LP-gas regulators, LP-Gas lines, and electrical motor base plug to code. The present invention further contemplates including the proper clearance for under mounting of gas lines (along the underside of the base frame of the cargo trailer) because it is required by code that the gas lines enter the unit from underneath.

The present invention embodies not only a new frame design but a frame design that can be retrofitted to a less structurally robust existing cargo trailer to accommodate the necessary systems to be used safely for its proposed application. In addition to the unique frame design of the present invention, it also has a specialized trim tray profile that enables passive air intake from the external environment for the passive cooling of the interior of the unit as well as vent locations near the floor that provide air intake to cool the condenser coils of equipment.

The present invention thereby allows for the transforming of an enclosed cargo trailer into a commercial kitchen, office, or workspace of any type, be it built from scratch with the MKS frame design embodied in the present invention or via retrofitting existing frames using several of the MKS's components. The present invention complies with the most up to date commercial building codes, such as National Fire Protection Association (“NFPA”) 70, 96, 54 and 58 along with NLIV 1192.

In one aspect of the present invention, a system for an enclosed mobile commercial structure, the system includes the following: a base frame; a wall assembly along a substantial portion of a periphery of the base frame so as to define the enclosed mobile commercial structure, wherein one or more of a plurality of wall wiring joists of the wall assembly circumscribing a plurality of wiring holes, wherein each wiring hole is dimensioned and shaped to carry electrically wiring from an electrical source external to the enclosed mobile commercial structure and an electrical panel within an interior of the enclosed mobile commercial structure; and a ceiling assembly extends between an upper portion of the wall assembly.

In another aspect of the present invention, the system for an enclosed mobile commercial structure further includes wherein each wiring hole is at least one-and-a-half inch from an adjacent wiring hole, and wherein each wiring hole is at least one-and-three-quarters inch from an edge of the wiring joist, wherein one or more of a plurality of ceiling wiring joists of the ceiling assembly circumscribing a plurality of said wiring holes so that the electrical wiring can be carried from the wall assembly and through the ceiling assembly; further including a mechanical wall assembly offset from the wall assembly, wherein said electrical wiring directly connects to the mechanical wall assembly by way of the ceiling assembly, wherein the mechanical wall assembly houses the electrical panel, wherein the mechanical wall assembly is at least eighteen inches in width, wherein the plurality of ceiling wiring joists comprises a plurality of ceiling wiring joists and a plurality of crossover wiring joists, wherein the plurality of ceiling wiring joists provides wiring holes oriented lengthwise relative to the enclosed mobile commercial structure, and wherein the plurality of crossover wiring joists provide wiring holes oriented widthwise relative to the enclosed mobile commercial structure so that the electrical wiring traverses the enclosed mobile commercial structure lengthwise and makes turn to traverse the enclosed mobile commercial structure widthwise, respectively, wherein at least one wiring hole has a grommet is operatively associated therewith; further including two attachment points along the wall assembly for accommodating an exterior installation of a fuel tank rack; further including a trim tray along said interior adjacent an interface of the wall assembly and the ceiling assembly, wherein the trim tray is configured to provide passive air flow for cooling and a source of makeup air of an exhaust system for the enclosed mobile commercial structure; further including a center tube extending from an apex of an A-frame of the base frame for a distance approximately equal to one-third of a length of the base frame, wherein the center tube is configured for placement of equipment and loading throughout the base frame; further including a plurality of gas line hangers connected along an underside of the base frame, wherein each gas line hanger has a gas line engager disposed approximately four inches below the underside of the base frame; further including a plurality of gas line hanger connected along an underside of the base frame, wherein each gas line hanger has a gas line engager disposed a predetermined clearance above an axle operatively associated with the enclosed mobile commercial structure, wherein the predetermined clearance is approximately four inches; and further including an offset member between an axle hanger operatively associated with said axle and the underside of the base frame to further maintain the predetermined clearance.

These and other features, aspects and advantages of the present invention will become better understood with reference to the following drawings, description, and claims.

### BRIEF DESCRIPTION OF THE DRAWINGS

FIG. 1 shows various PRIOR ART enclosed cargo trailer frames. These current industry standard frame units are retrofitted into all kinds of applications that require basic and advanced electrical systems, LP-gas systems and water systems; however, no accommodation within the frame to facilitate these things being done to the relevant building codes.

FIG. 2 shows various PRIOR ART installations of wiring, plumbing, and gas lines systems of “up-fitted” enclosed cargo trailer frames that do not meet code, as “standard” installation methods for electrical systems in the retrofitting of enclose cargo trailers fail to provide, among other things, protection of the wires. Note the 240-v panel next to the water system and exposed electrical outlets as well as a panel only inches from the floor and exterior hole, and notice the proximity to water, water lines, water pumps, exposed wire, improper wiring technique and components.

FIG. 3 shows various PRIOR ART installations of wiring and insulation along the ceiling and roof of “up-fitted” enclosed cargo frames that do not meet code; specifically, wires are simply draped over the top of the roof joists, bundled together and just haphazardly placed behind the walls and ceiling with no protection, which results in such components being crushed, burned, gouged, cut, grounded out etc.

FIG. 4A is a perspective view of an enclosed frame according to an embodiment of the present invention.

FIG. 4B is a front elevation view of an enclosed frame according to an embodiment of the present invention.

FIG. 5A is a side detail perspective view showing an exterior wall assembly and an internal mechanical wall assembly according to an embodiment of the present invention.

FIG. 5B shows another perspective view of FIG. 5A.

FIG. 6A is a side detail perspective view showing an exterior wall assembly and past that, the layout of a ceiling assembly according to an embodiment of the present invention.

FIG. 6B shows another perspective of the mechanical wall assembly and the ceiling assembly from an interior vantage point.

FIG. 7A is a perspective view of the wiring alignment and protection structure along the ceiling assembly according to an embodiment of the present invention.

FIG. 7B is a perspective view of the wiring alignment and protection structure along the ceiling assembly according to an embodiment of the present invention.

FIG. 7C is a detailed perspective view of the wiring alignment and protection structure along ceiling joists of the ceiling assembly according to an embodiment of the present invention.

FIG. 7D is a detailed perspective view of the wiring alignment and protection structure along wall joists of the wall assembly according to an embodiment of the present invention.

FIG. 8 shows proper insulation, walls, and wiring protection within a frame of the enclosed cargo trailer. As can be seen, a wall angle is attached to the vertical studs to protect the wiring from screws or nails and the wiring is tucked in close to the vertical wall studs behind the wall angle and then transfers over to the receptacle box. The wall angle can be one piece in a U-type shape or an L-Shape. Two L-Shapes can be used as well. This is the only way to protect the electric lines as they transition from the ceiling down to the wall cavities. It is also possible to use an H-shape to achieve the same thing.

FIG. 9 shows an interior finish placed on the frame of the present invention, illustrating a standard finish for the system embodied in the present invention with the mechanical wall on the driver's side of the unit. Note, it can also be reversed to the passenger side as well as the back of the unit on both sides of the trailer if needed. There are gooseneck and V-Nose presentations.

FIG. 10A shows a trim tray vent 140 placed along the finished interior of structural shell 20 of the present invention, at the interface of the ceiling and the wall board; clearly illustrating the perforations and the design layout for the vent as it is incorporated into the top ceiling tray. The trim tray vent allows for air to pass through the walls of the trailer and vent heat between the walls and supply makeup air for the system. This design can be used in any application to provide a methodology of venting an enclosed trailer. The design can take the shape of a (U), (S), Modified (S or U) or even a type of (Z) shape. Importantly, the trim tray vent extends from the wall a certain distance so that it can attach to the wall or ceiling assembly and that an installer can attach the trim or extrusion to it.

FIG. 10B is a section view of the finished interior of structural shell of the present invention, illustrating the trim tray vent 140 being engaged by the trim tray 141 at the interface of the ceiling and the wall board.

FIG. 11 shows additional interior and exterior finishes placed on the exterior structural shell 20 of the present invention to accommodate the components in a manner to facilitate building any type of concession and vending machine application, whereby the system of the present invention can ensure that the electrical setup will meet with all NFPA 70 codes and make these types of de-signs perfectly safe for all consumers.

FIG. 12 is a top plan view of a base chassis of the frame according to an embodiment of the present invention.

FIG. 13A is a top plan view of the base chassis of the base frame with highlighted components according to an embodiment of the present invention.

FIG. 13B is a side view of the enclosed frame with highlighted components according to an embodiment of the present invention.

FIG. 14A is a side elevation of a vertical wall of the wall assembly of the enclosed frame according to an embodiment of the present invention, illustrating one variation of a back wall having a door opening.

FIG. 14B is a side elevation of a vertical wall of the wall assembly of the enclosed frame according to an embodiment of the present invention, illustrating wall studs, a front header, a front bumper, corner post, and horizontal wall studs for a gas tank frame assembly.

FIG. 15 is an external side elevation view of a cooking side of the frame according to an embodiment of the present invention.

FIG. 16 is an external side elevation view of a concession side of the frame according to an embodiment of the present invention.

FIG. 17 is a top plan view of the ceiling assembly/roof system according to an embodiment of the present invention, illustrating locations of mechanical system access through the roof.

FIG. 18 is a detailed elevation view of the front of the frame, from the inside with components overlayed, according to an embodiment of the present invention.

FIG. 19 is a detailed elevation view of the front face of the mechanical wall with highlighted components according to an embodiment of the present invention, illustrating a mechanical assembly.

FIG. 20 is a detailed elevation view of a ceiling joist of the ceiling assembly according to an embodiment of the present invention.

FIG. 21 is a detailed elevation view of a ceiling joist 36 of the ceiling assembly according to an embodiment of the present invention.

FIG. 22 is a detailed elevation view of a ceiling cross over joist 38 of the ceiling assembly according to an embodiment of the present invention.

FIG. 23 shows various PRIOR ART gas line installations of “up-fitted” enclosed cargo frames that do not meet code by way of improper gas line installations common within the industry. Note the improper placement, type of gas line, gas line connectors and improper fire wall or no firewall in the lower picture—this would never be allowed to pass in any type of brick-and-mortar building.

FIG. 24A is a perspective view of gas line installations within an internal space, according to an embodiment of the present invention, illustrating the gas lines come through the floor, with individual shutoff valves for each piece of equipment per building code, in relation to everything else.

FIG. 24B is a perspective view of gas line installations shown in use along the floor of the internal space with proper cutoffs for each piece of equipment affording by the frame design of the present invention.

FIG. 25 shows various prior art gas line installations along the underside of PRIOR ART food trucks that are “up-fitted” enclosed cargo frames that do not meet code. Note that they have improper attachment points, placement, improper type of gas line, improper gas line connectors, improper sizing of components, and insufficient clearance for the gas line, wherein every bump in the road may cause the axle to hit the gas line, not to mention the bending of the line around the water tank. This type of careless installation should never be allowed yet it is standard within the industry, and nobody is checking for this.

FIG. 26 is a perspective view of an underside of the base chassis of the base frame illustrating proper clearance of the under mounted gas line. Note that there is a minimum of 4″ of clearance from the bottom of the gas line to the top of the axle and that there are proper attachment clamps designed for gas line installation.

FIG. 27 shows various PRIOR ART (LP) gas tank installations on “up-fitted” enclosed cargo frames that do not meet code since such gas tanks should connect only to flexible high-pressure hoses. Also note that there is no cover and protection for the LP-gas regulator and tanks themselves, as well as no signage/warning labeling as well as improper location placement. This type of carless installation should never be allowed yet it is standard within the industry, and nobody is checking for this.

FIG. 28 shows LP-gas tank holder and tank rack installations within a frame according to an embodiment of the present invention. Note the proper cover and protection of the tank and its regulator along with proper attachment points and the proper warning labels and placards. Also, proper high-pressure flexible connection lines are used and there is proper ventilation.

FIG. 29 shows end results and the damage caused by PRIOR ART installations that lack proper installation location and cover, as well as improper securing, improper connections etc.

FIG. 30 shows both a typical internal view of a properly installed cook line with proper gas lines, fire wall, hood installation and fire suppression as well as a front-end layout within a frame according to an embodiment of the present invention. Also shown is the proper external location and installation of the LP-tanks, generator, fuel tank for the generator and the proper warning placards, all installed to code. The base frame 10 is designed to accommodate all these items correctly.

FIG. 31 shows PRIOR ART equipment installations. Showing attic fans being used on the hoods, no hood with filter only and an improperly designed hood with non-grease rated venting. All with no proper firewall or fire suppression which is required by code.

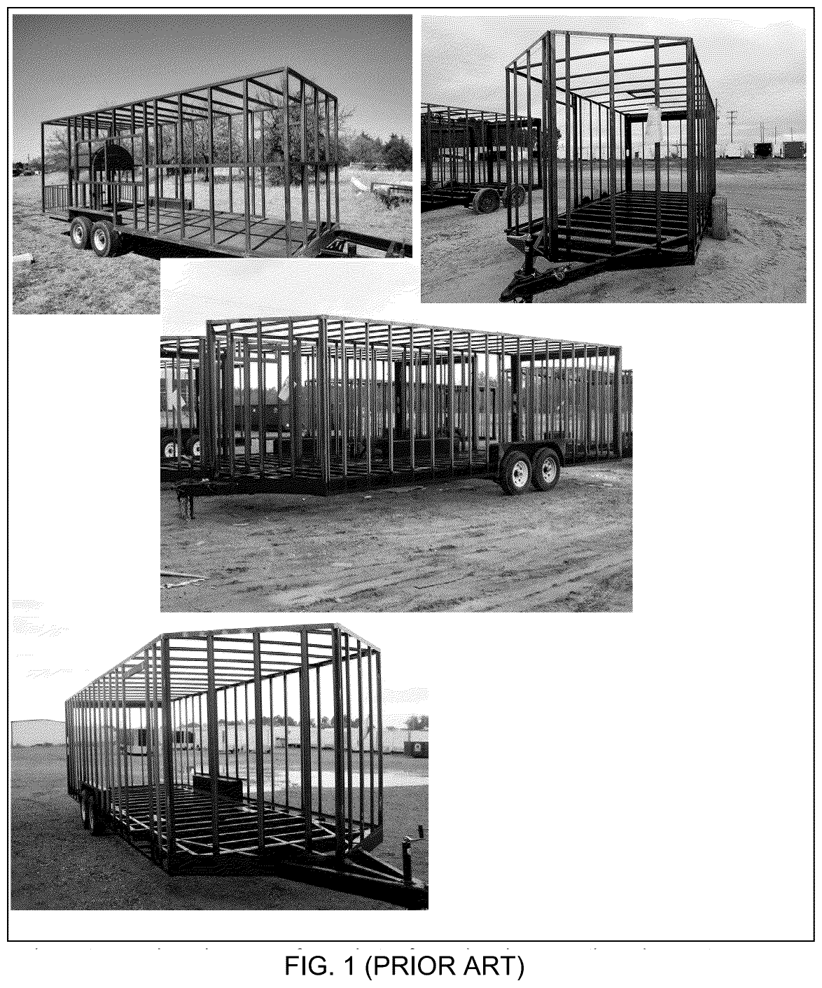

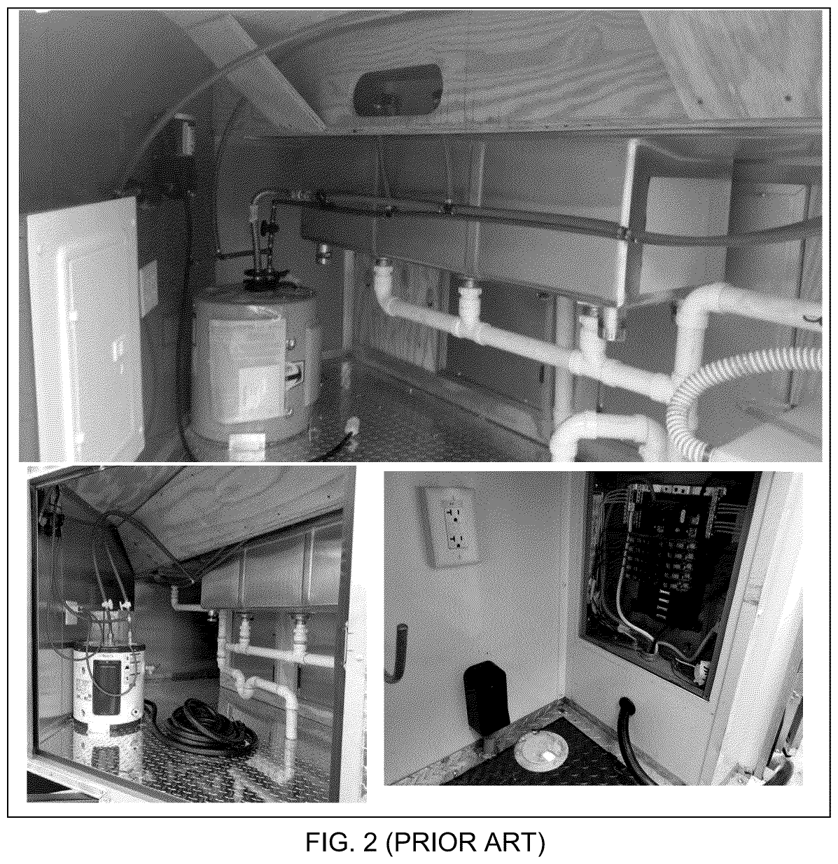

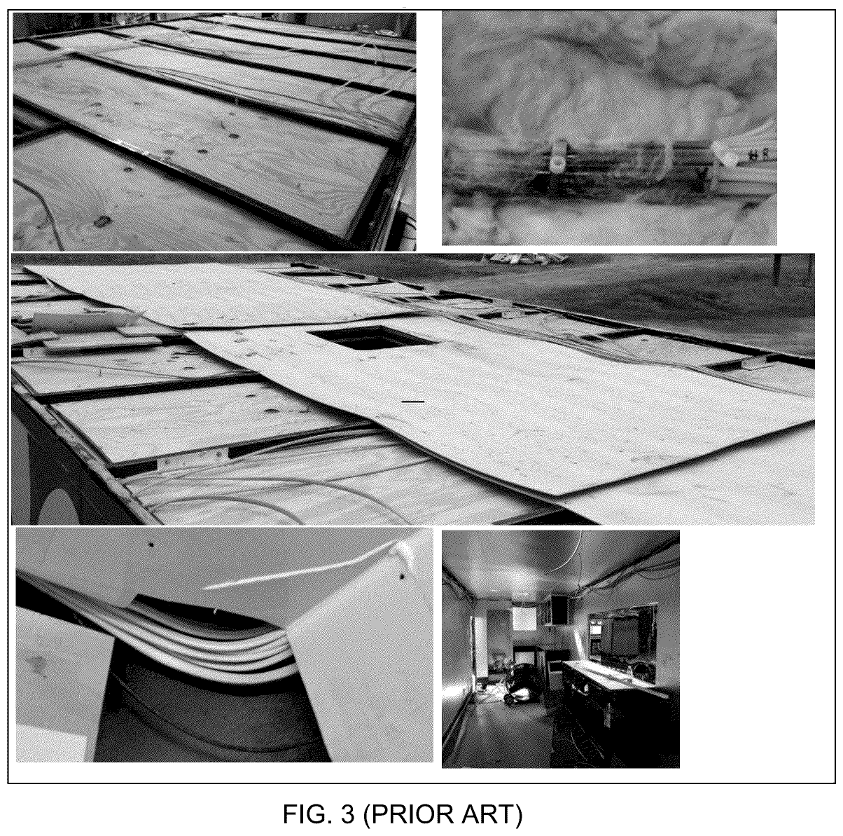

### DETAILED DESCRIPTION OF THE INVENTION

The following detailed description is of the best currently contemplated modes of carrying out exemplary embodiments of the invention. The description is not to be taken in a limiting sense but is made merely for the purpose of illustrating the general principles of the invention, since the scope of the invention is best defined by the appended claims.

Broadly, an embodiment of the present invention provides an enclosed structural system for a mobile commercial enterprise so that the resulting vehicle can accommodate all the MEP systems needed to pass all codes. In addition, applying the three main components of the embodied structural system to an existing cargo trailer style frame transforms it into a concession trailer that can meet the relevant building codes. The structural system provides a structural component, or shell, over a base frame/chassis. The shell is defined by a structural wall assembly and ceiling assembly. The shell of the present invention has a structural component for structurally supporting, via ceiling joists and vertical members, roof panels and wall panels, respectively. The structural components may include corner posts, roof headers, as well as other structural components that define a structural shell defining an enclosure over the base frame.

The enclosed structural system embodies systemic electrical components providing a plurality of electrical protection features. For instance, the ceiling assembly includes ceiling joists, and the wall assembly includes wall joists that properly carry electrical wiring from a main power line, into an electrical panel, and throughout the interior space of the enclosed structural system. Between the ceiling joists and the vertical members are cross ceiling supports and cross wall supports, respectively, that carry electrical wiring a safe distance from the exterior environment as well as maintain proper clearance between the individual wires to avoid tangling, which invites electrical shorts.

The enclosed structural system also provides a mechanical wall that protects the electrical panel. The mechanical wall is located within the internal space of the enclosed structural system, to separate and protect the electrical panel. The mechanical wall assembly is spaced apart from the vertical members of the wall assembly of the shell, thereby protecting an electrical panel and other electrical power interfaces so that they are physically separated from other MEP components and exterior walls.

The enclosed structural system has systemic gas component, including a gas tank protective cage (not shown) as well as features such as undermounted spacers between the shell and the base frame to properly support gas lines under the base frame yet safely above the axles of the vehicle's wheels. Accordingly, the present invention embodies 4×2 hanger spacers between a lower surface of the base frame and axle mounted supports so that a plurality of axle hangars depending from said lower surface of the base frame may safely carry a gas line above the axle so that when there is a bump in the road the axle will not hit the base line. The structural shell may integrate support for proper installation of an LP tank rack and strap assembly.

The enclosed structural system allows for safe installation of electrical wiring, gas lines, plumbing, pneumatic powered, liquid transport systems, generators, and similar systems needed for mobile commercial structures. Thereby, the structural system creates a complete shell design for an enclosed cargo trailer that allows for meeting building code requirements and ensuring the safety of business operators, employees, and the public.

Referring to the Figures of the prior art, including the figures of the provisional patent application, 63/508,110, filed Jun. 14, 2023, incorporated by reference herein, exemplary prior art frames for cargo trailers are shown, illustrating that while manufacturers have changed the size, thickness, and profile of the frame members for an enclosed cargo trailer, none of them have created the components necessary to protect the base wiring of electrical systems, the lines of gas systems, or the lines of plumbing systems in retrofitted trailers for commercial use. Thus, retrofitters of current frame designs for enclosed cargo trailers simply hide the wires or lines and do nothing to protect the wires or lines from metal contact, heat, compression, tension, screws, distance from wire to wire, and/or environment.

The current enclosed trailer framing of the prior art is made of metal tubes or formed metal profiles in which the electrical system wiring, gas lines, or plumbing are simply laid over or taped to the frame members. Many times, the wires and lines are loose, or zip tied together in bundles. The roof is then laid over the unprotected electrical wires and lines, exposing the wires and lines to all types of damage; for instance, by screwing a fastener though the roofing where the fastener may electrically couple to an electrical wire less than an inch below the roof. Current enclosed trailer framing has wall thicknesses of one inch or less and wiring and lines are simply dropped down and connected with no protection from inside/outside screw penetration. Electrical panels are set anywhere in current enclosed frame trailers and do not follow any existing building codes, with wires coming into the electrical panels that are not properly spaced apart from exterior walls nor are they protected with standard wire cable clamps or conduit connectors as they should be and are within the MKS design embodied in the disclosure.

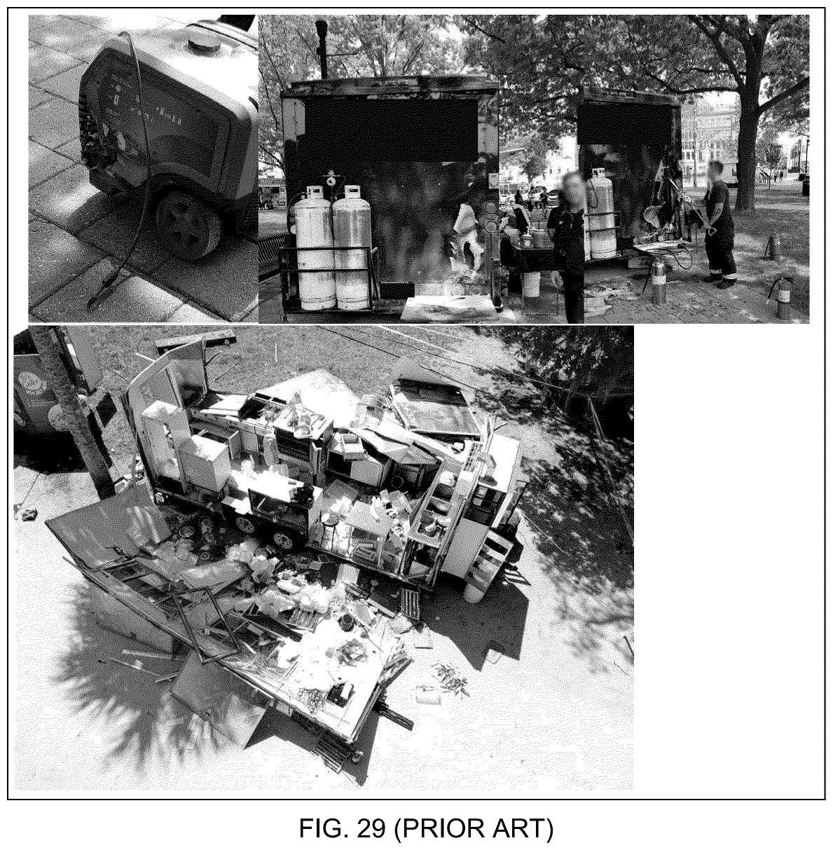

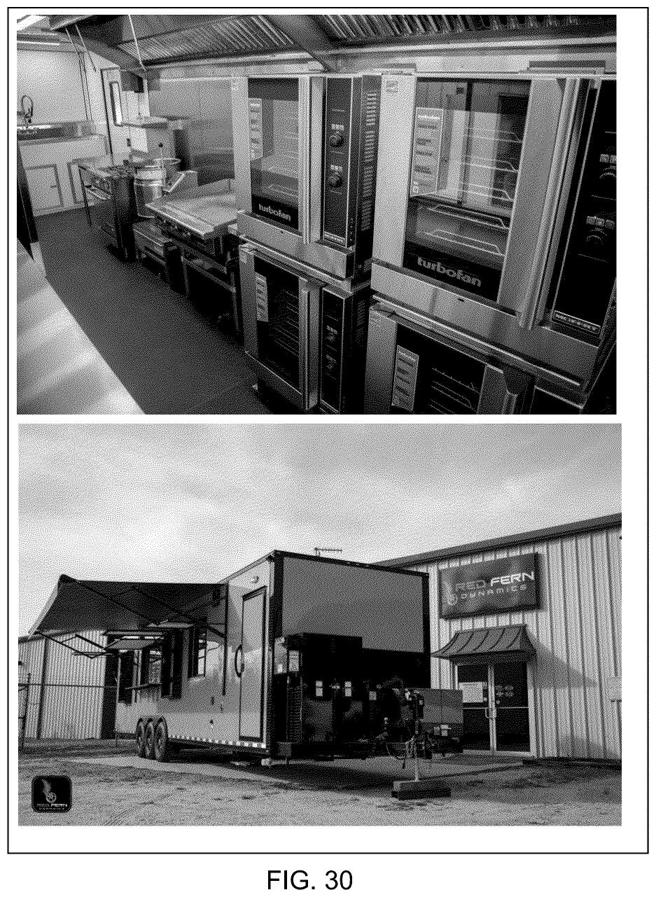

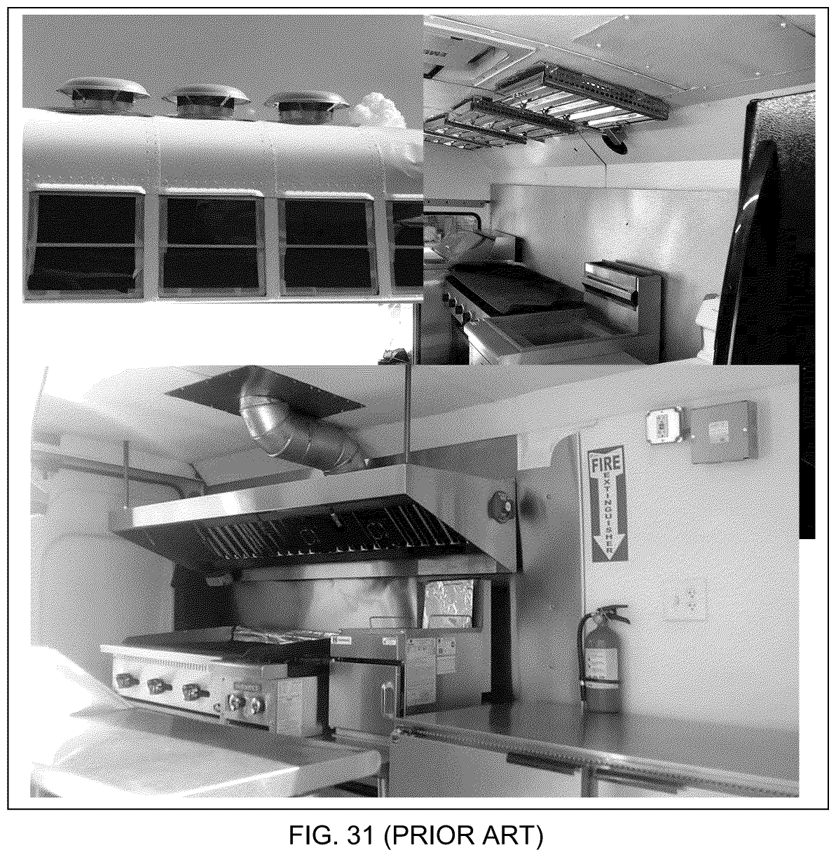

Further, the spacing of base frame of the cargo trailer and axles does not allow for proper LP-Gas line installation. As best seen in FIG. 29 the prior art application of LP-Gas line support fails to follow regulations and can result in severe and potentially deadly consequences.

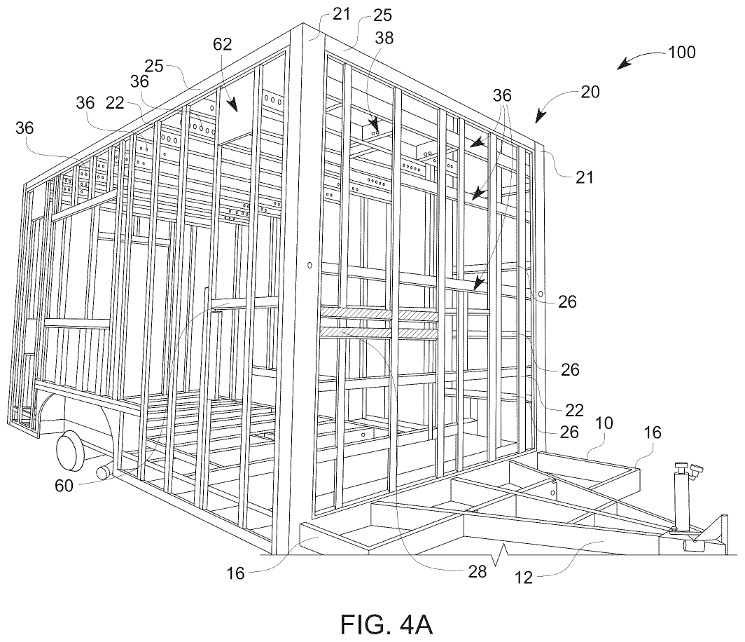

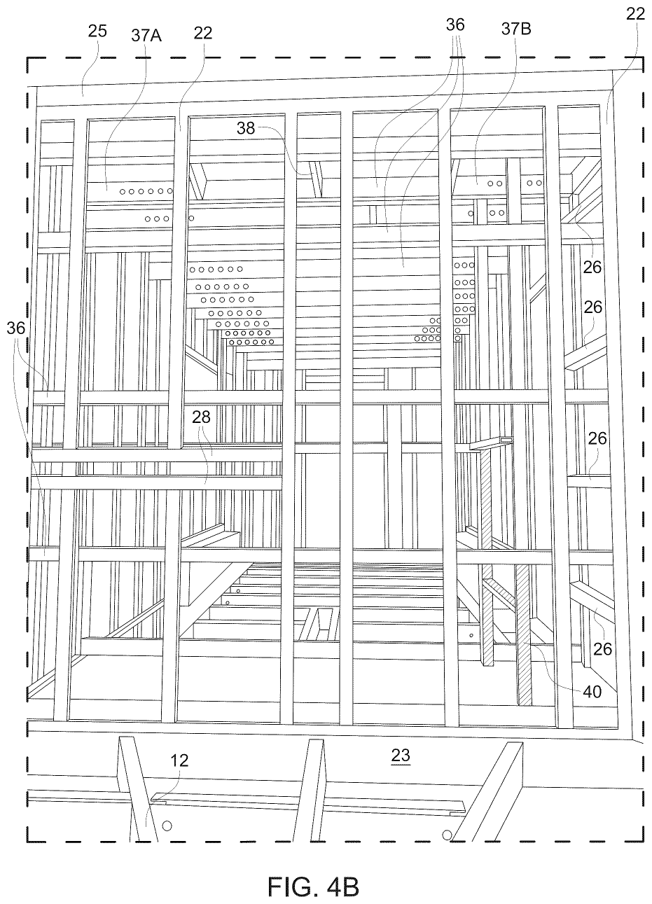

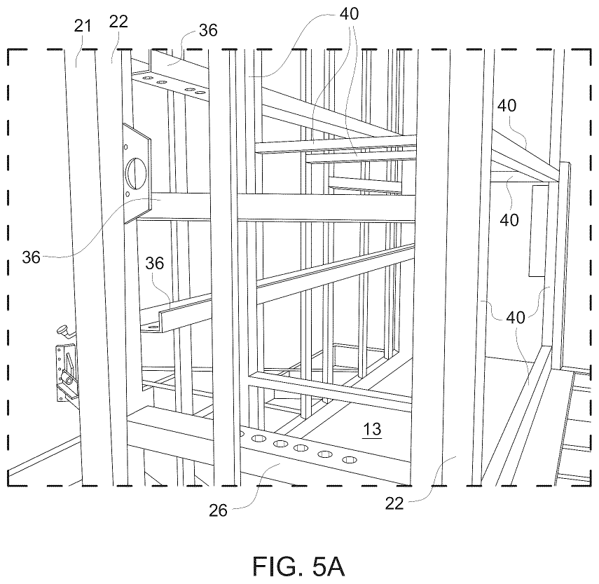

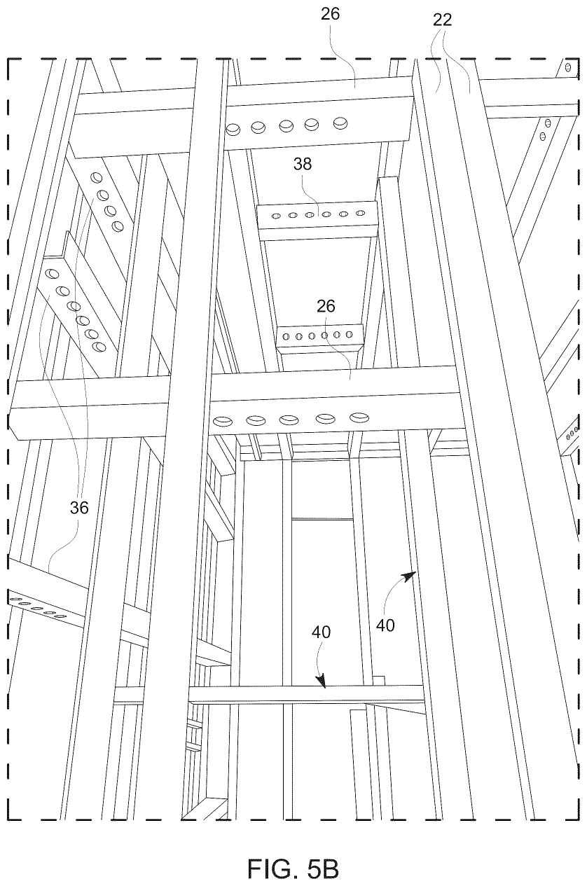

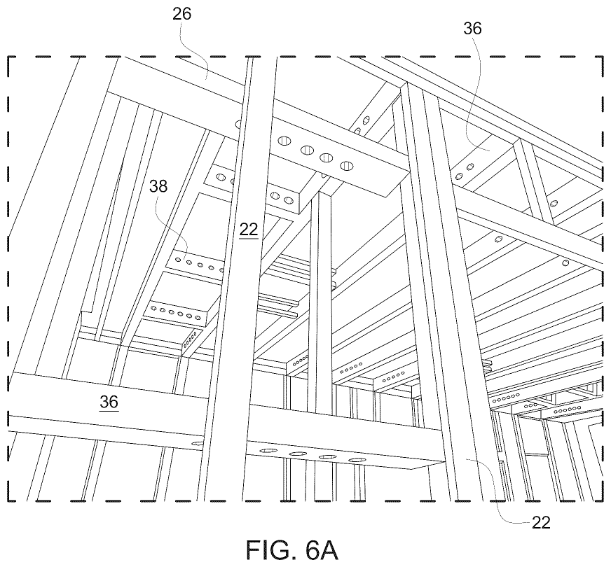

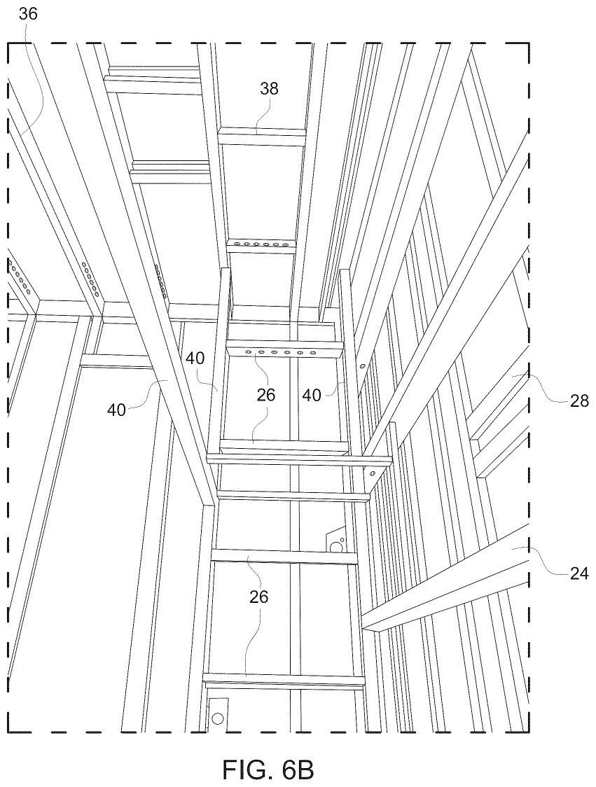

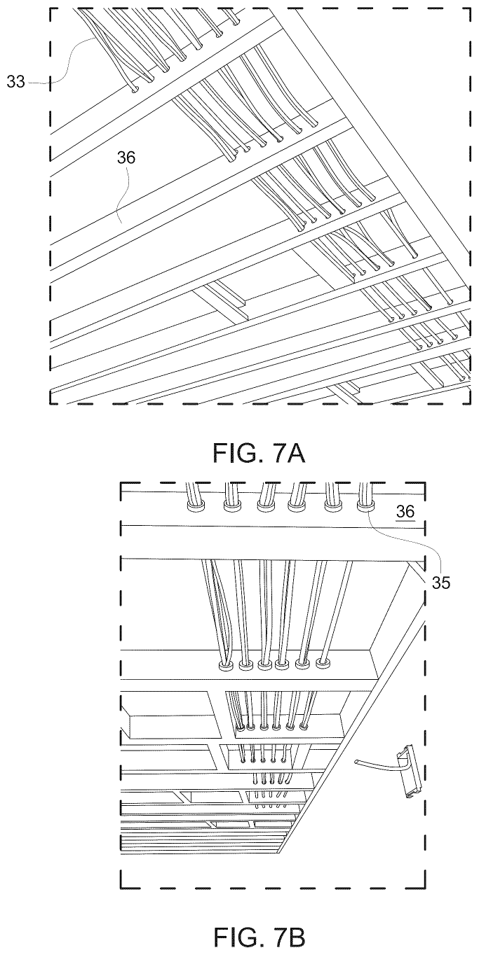

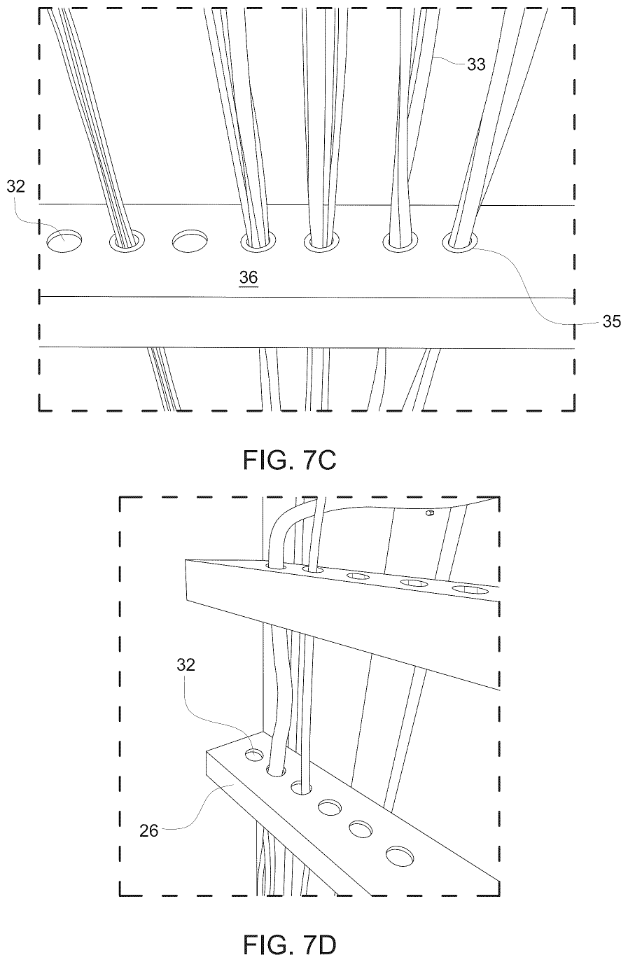

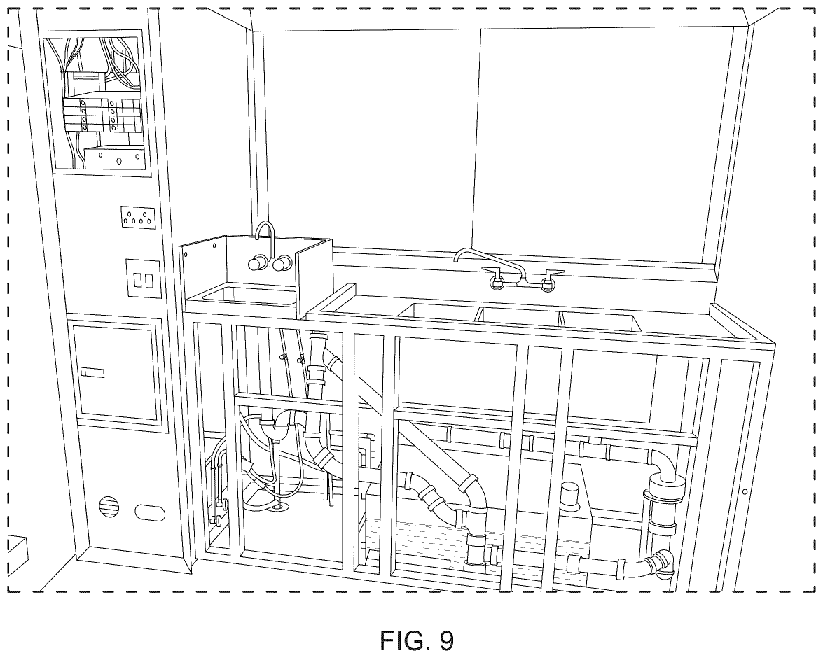

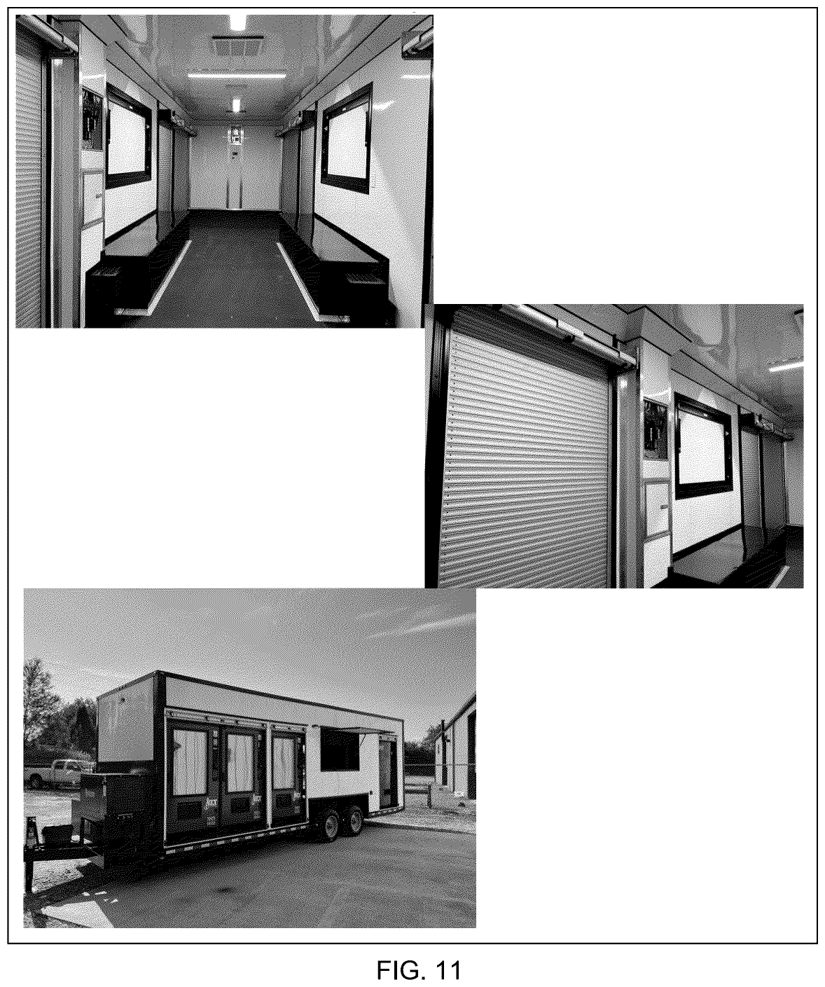

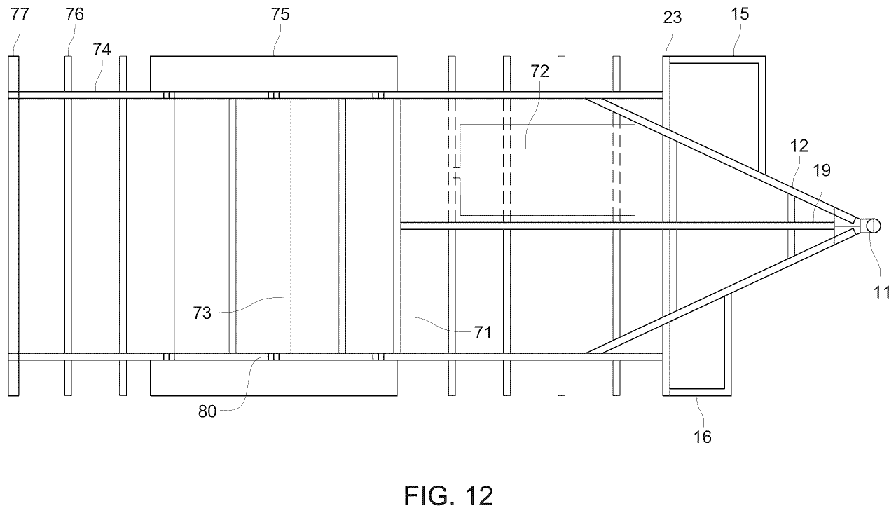

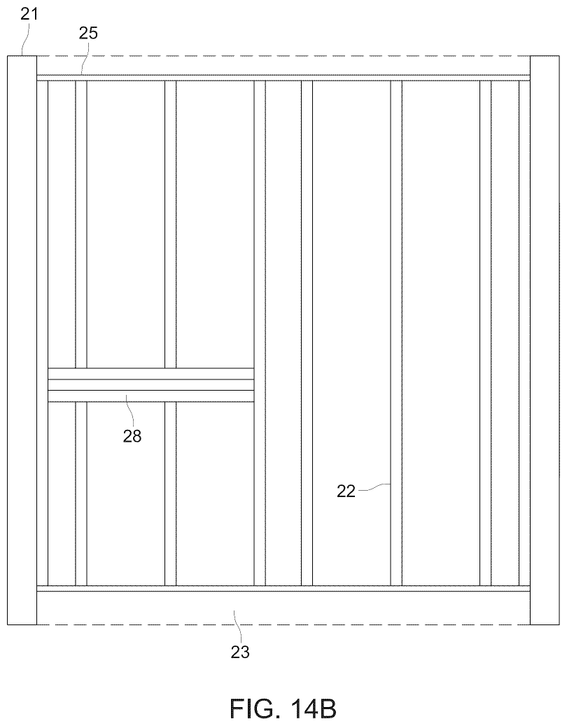

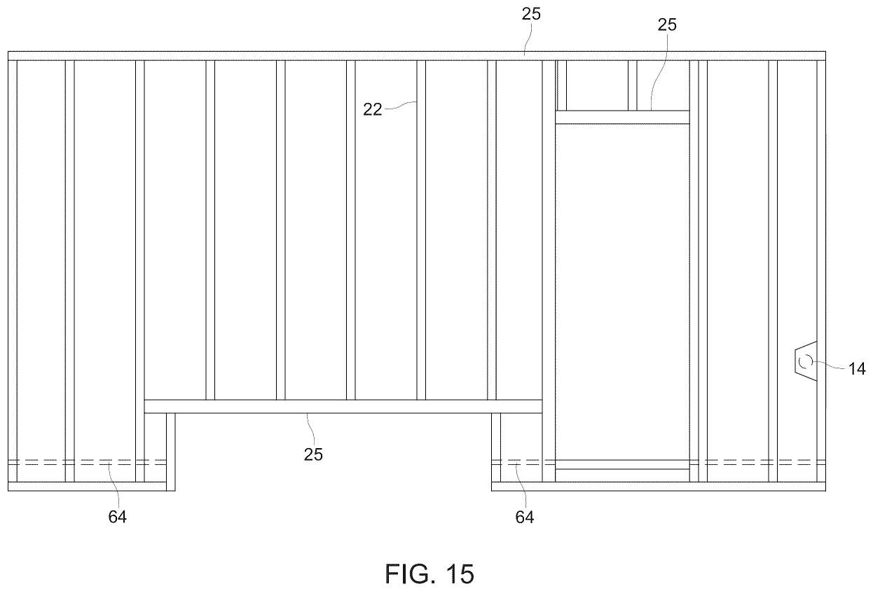

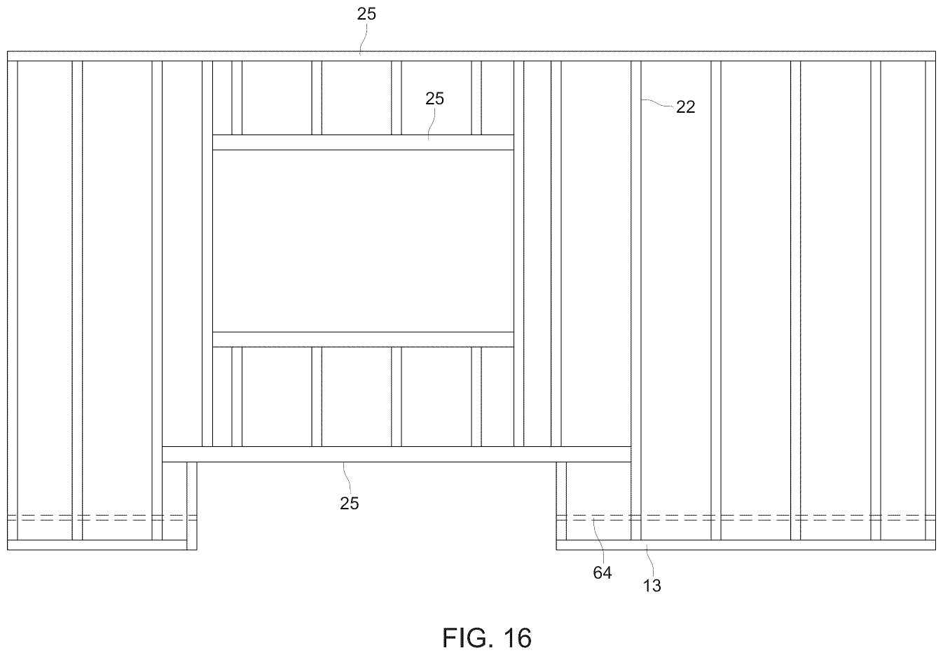

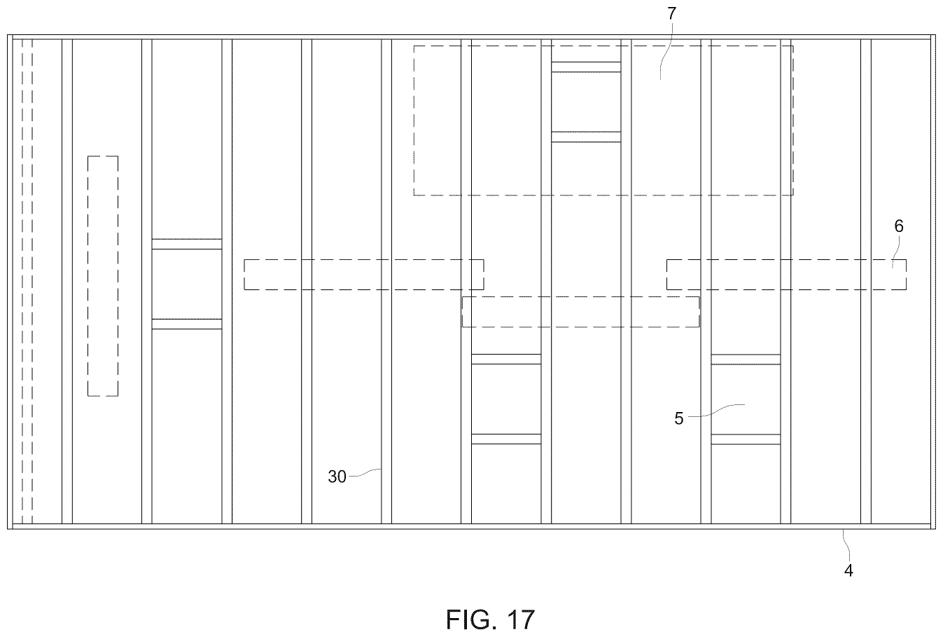

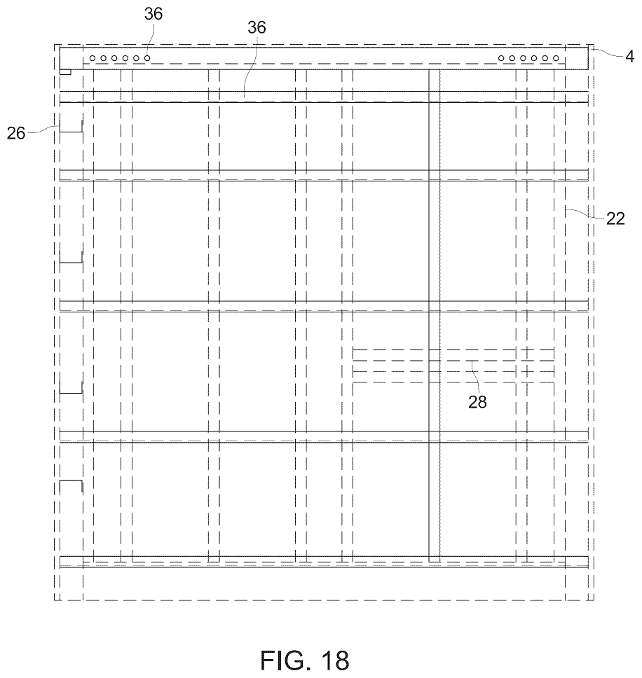

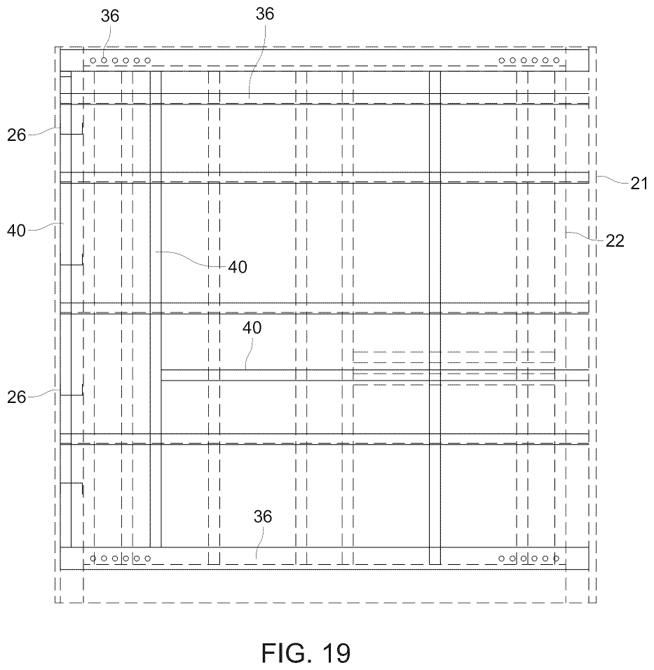

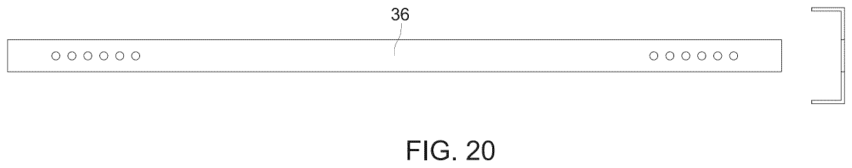

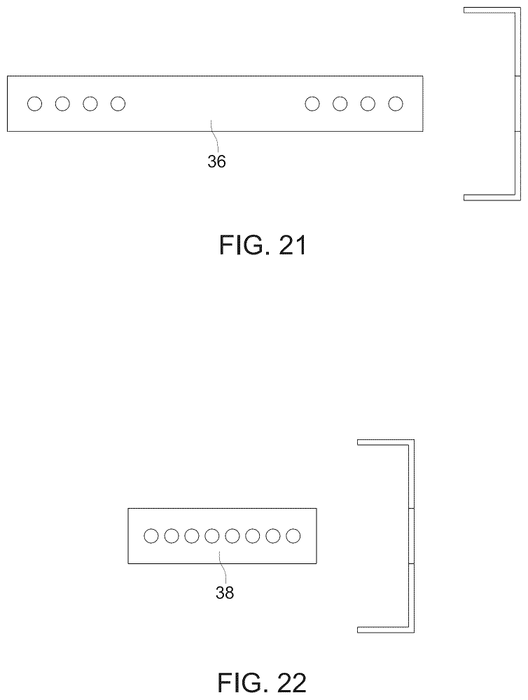

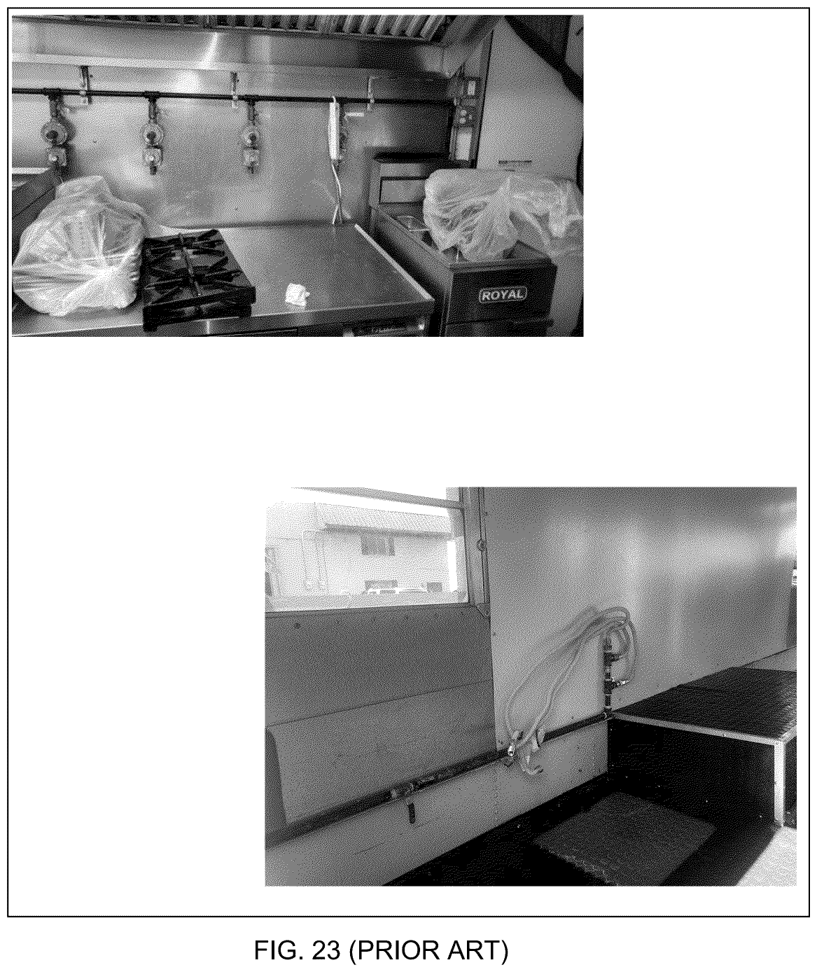

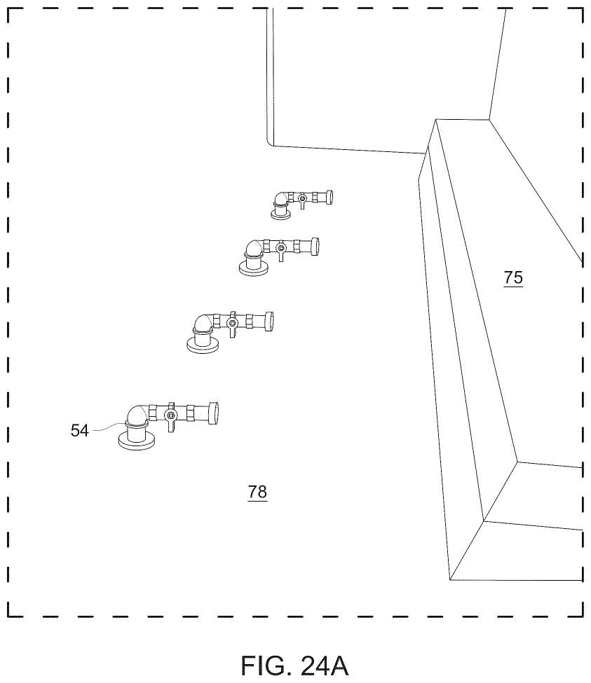

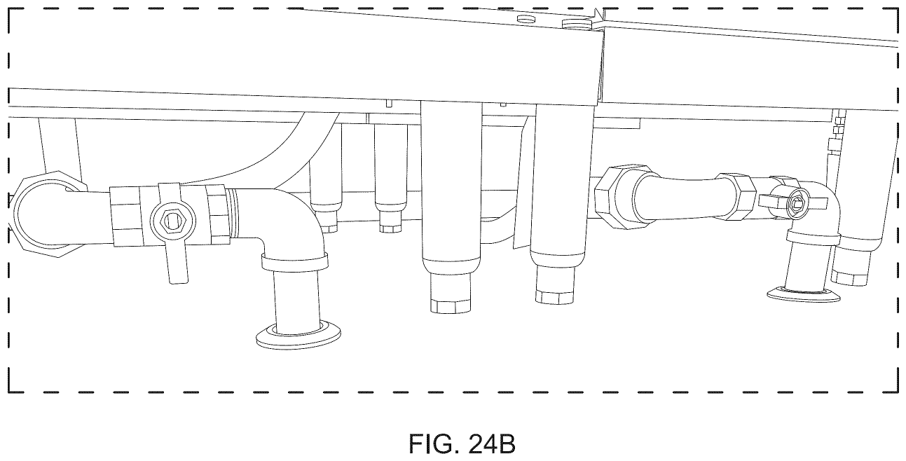

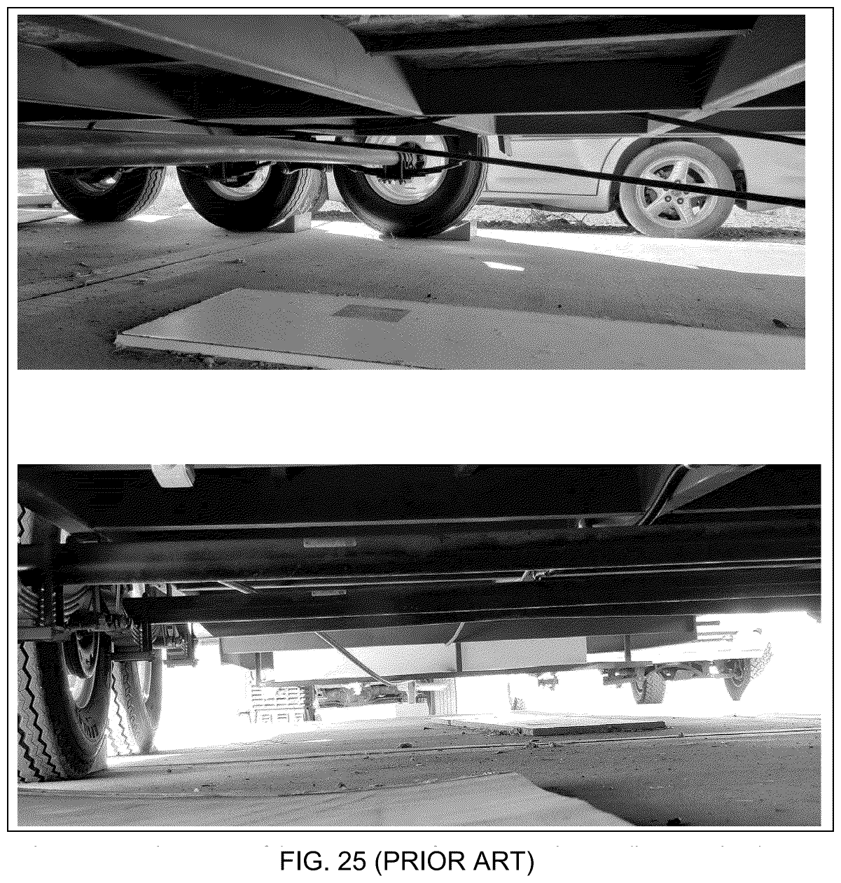

Referring now to FIGS. 4A through 26, an enclosure structural system 100 according to an embodiment of the present invention is shown. Enclosure structural system 100 includes a base frame assembly 10 that carries a structural shell 20 that defines an interior space of a mobile commercial enterprise.

The exterior structural shell 20 includes vertical members 22 spaced apart along the periphery of the base frame assembly 10 to define walls of the exterior shell 20. The vertical members 22 include the corner posts 21. Headers 25 and bumpers 23 are also incorporated in the exterior structural shell 20 design.

At certain locations, a plurality of wall joists 24 interconnects adjacent vertical members 22, including spanning between corner posts 21. The plurality of wall joists 24 may include headers 25 to define an opening through the exterior wall or are provided to otherwise provide support for finishing the exterior wall.

There are additional systemic wall joists that serve two specific purposes, including wiring wall joists 26 and fuel tank rack attachment points 28. At certain locations, between two adjacent vertical members 22 or posts 21 a plurality of wiring wall joists 26 is connected in a spaced apart relationship. Each wiring wall joist 26 provides a plurality of spaced apart wiring holes 32. Each wiring hole 32 is dimensioned and adapted to slidably receive wiring 33 carry electricity from a main power line (shoreline) into the enclosure structural shell 10. Each wiring hole 32 may be reinforced by a grommet 35. For instance, a plurality of wiring wall joists 26 may extend between two vertical members 22, i.e., across one bay, wherein such a single bay, each wiring wall joist 26 of the set wiring wall joists 26 are in alignment relative to each other and vertically spaced apart and aligned (as are their plurality of wall wiring holes 32) with that one bay.

The wiring wall joists 26 may be any length sufficient to span a distance between adjacent framing elements of wall assembly of the enclosure structural shell 20. The wiring holes 32 of the wiring wall joists 26 may be sized and shaped to accommodate utilities needed for a business of a user of the frame design. For example, the plurality of vertical wall joist holes may include eight vertical wall joist holes extending across the wiring wall joists 26 starting 1¾ inches from a respective end of the wiring wall joists 26, each wiring hole 32 being one inch in diameter and spaced 1½ inches apart from at least one other wiring wall joists 26 wiring hole 32. The wiring wall joists 26 may be installed in a horizontal plane, thereby allowing wires or lines to traverse in both a vertical and horizontal manner throughout the frame design.

The vertical members 22 may comprise any suitably strong and durable material that meets building code requirements, such as metal tubing. Each wall assembly may be formed to have unique features, such as a plurality of doors, a plurality of windows, or other features that allow a business using the frame design to provide both pedestrian and commercial access to the frame design. For instance, a sink basin member 60 or an awning base plate 62 may be disposed along a side wall assembly of the enclosure structural shell 20.

Further, a front wall assembly of the enclosure structural shell 20 may be constructed to accommodate exterior installation and attachment of a fuel tank rack, by way of attachment points 28, as seen in FIG. 4A. The fuel tank rack attachment points 28 may be horizontal members spanning between vertical members 22. The fuel tank rack attachment points 28 are disposed over the fuel tank base 16 that is operatively associated with the A-frame 12 of the chassis of the base frame 10. The A-frame 12 may also provide a generator base 15 for supporting a generator. The A-frame may have a supportive center tube 19 that terminates adjacent a coupler 11.

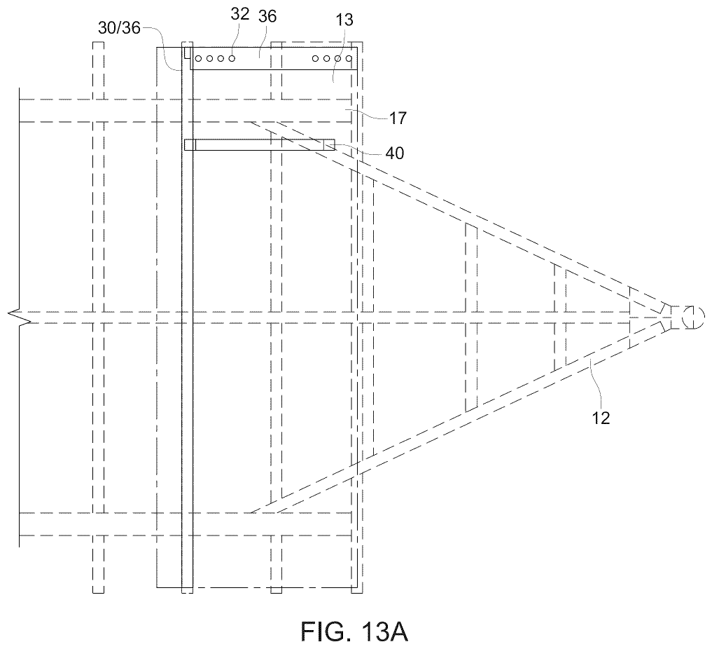

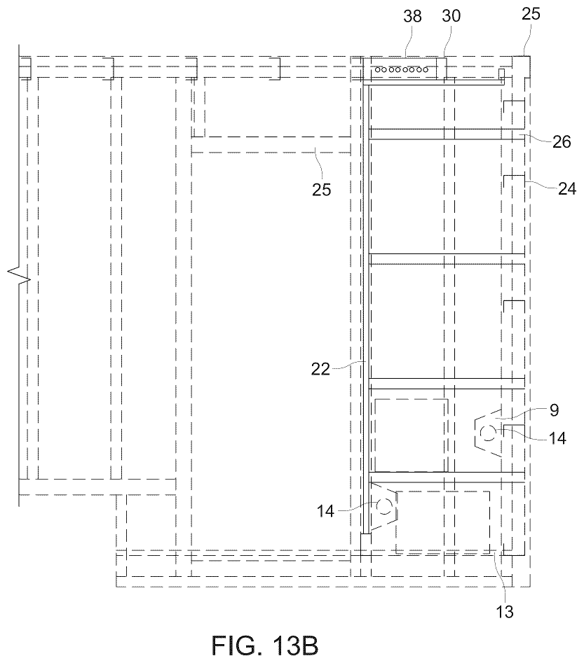

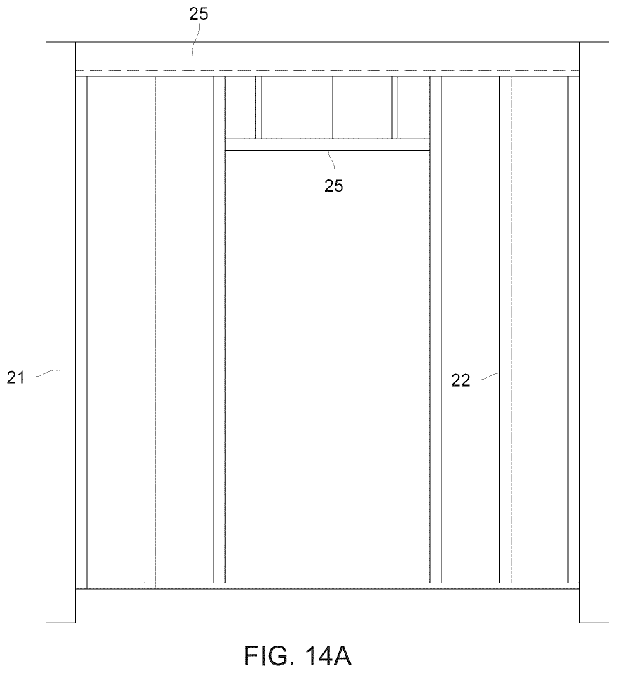

The enclosure structural shell 20 may further include a motor base plate 9, as seen in FIG. 13B, configured to connect to one or more wall assemblies to accommodate a motor base plug base 14. The motor base plate 9 may be adjusted to meet the electrical needs of the business or person using the enclosure structural shell 10. For example, the motor base plate 9 may comprise a 4/5 wire cam-lock connection base plate. Further, the motor base plug base 14 may include a plate with a minimum thickness of ⅛ inches that is welded to at least one vertical wall stud and has a hole of no less than two inches in diameter to accommodate electrical wiring 33.

Along the floor, the base frame assembly 20 may provide a cross beams 71, main beams 74, outriggers 76, bumpers 77, and floor joists 73 to support a floor 78, a mechanical base plate 13 for a mechanical assembly 40, a water tank 72, and other needed or desired components. The base frame assembly 20 supports the wheel wells 75.

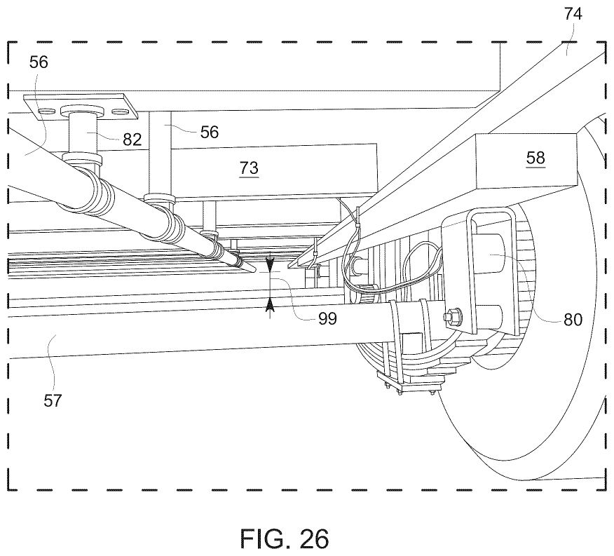

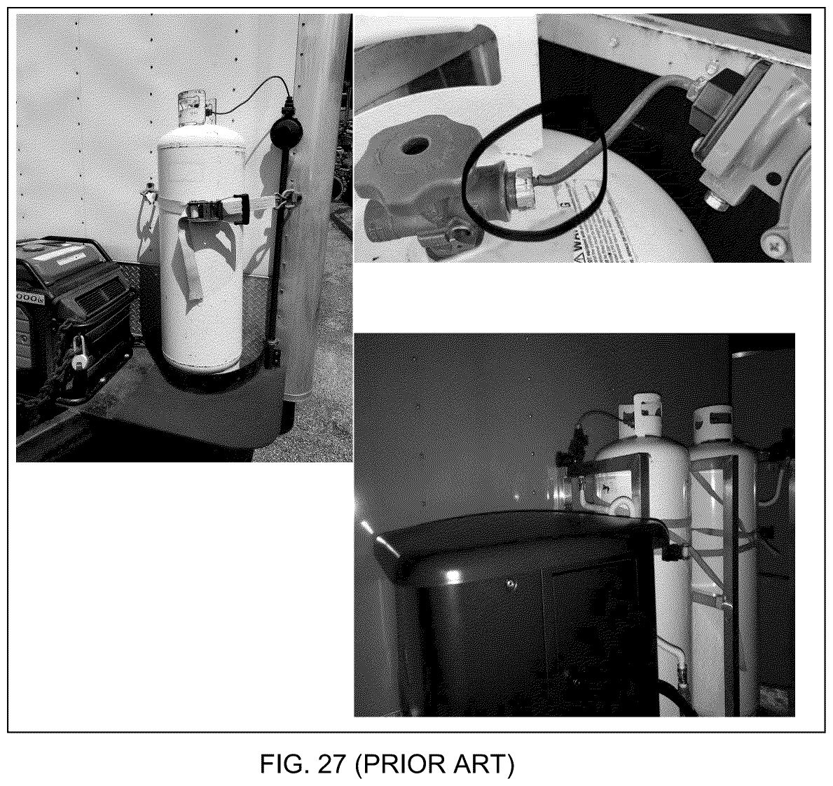

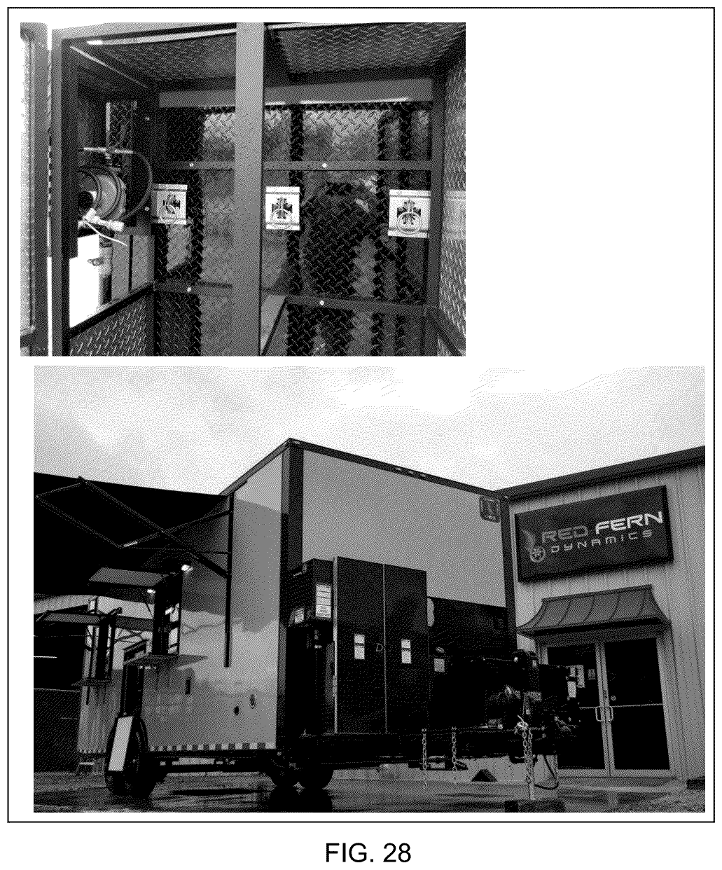

Along the underside of the base frame assembly 20, referring to FIG. 26, gas line hanger assemblies 82 may be hung from the floor joist so as to maintain a predetermine clearance 99 of the gas line 56 above the axle 57. The main beams 74 may have an offset member 58 between it and one or more axle hangers 80 to further maintain the predetermined distance 99. The offset member 58 is large enough to keep the gas lines 56 from ever being struck from the axle by its thickness.

Overhead, ceiling headers 25 span between corner posts, connected to the vertical members 22. Ceiling joists 36 and 30 extend between the ceiling headers 25 to define the ceiling of the shell 20. In some embodiments, between two adjacent ceiling joists 36 (adjacent to the bay of wiring wall joists 26) a plurality of wiring crossover ceilings joists 38 may be connected in a spaced apart arrangement. Each wiring crossover ceilings joists 38 provides a plurality of spaced apart wiring holes 32, wherein each ceiling wiring hole is dimensioned and adapted to slidably receive wiring 33 to carry electricity through the ceiling, whereby each ceiling wiring hole 32 is at least one and one-half inch from an edge of the associated wiring ceiling joist 36. Each wiring ceiling joist 36 may provide a set of ceiling wiring holes 32 just inward of each end. As a result, wiring 33 can be carried vertically from a main power line, through the plurality of wiring wall joists 26 up to and through the plurality of wiring ceiling joists 36, widthwise along the interior of the space enclosed by the structural shell 10, and in turn lengthwise through that space via one or the other sets of wiring ceiling joists 36. From time to time, the wiring ceiling joist 36 may be used as horizontal member along one or more of the wall assemblies of the enclosure structural shell 20.

More generally, the ceiling joists 36 or 30 may be any length sufficient to span a width of the frame design, for example, from just above zero inches up to a maximum one-hundred and two inches. The wiring ceiling joist 36 includes a plurality of ceiling joist holes 32 along the length of the ceiling joist 36, wherein the plurality of ceiling joist holes 32 provide space for the wires 33, or similar system components to be inserted through the wiring ceiling joist 36 with proper protection in all directions (either for high and low voltage wires or air lines, pneumatics or hydraulics, if needed). The ceiling joist holes 32 may be of any sufficient size and shape, to accommodate utilities needed for a business of a user of the frame design. Ceiling joists 30 are ceiling joists without ceiling joist holes 32.

For example, the plurality of ceiling joist holes 32 may include two sets ceiling joist holes 32, with two sets 37A and 37B of ceiling joist holes 32 formed on either end of the wiring ceiling joist 36 starting approximately six inches from a respective end of the wiring ceiling joist 36. Each hole 32 being approximately inch in diameter and spaced two inches apart from at least one other ceiling joist hole 32. For added protection of the wires or lines, a grommet 35, such as a rubber or plastic grommet, may be placed within each of the plurality of ceiling joist holes 32. Further, ceiling joist 36 may be used in a vertical position as portions of a mechanical wall assembly 40 and other wall assemblies of the frame design. The wiring ceiling joist 36 can, acting as vertical members 22, thus provide the ability to run utilities, e.g., electrical lines, in walls of the frame design in a horizontal manner if frame height is an issue.

At least one ceiling crossover joist 38 may be attached between ceiling joists 36 for the wiring, gas lines or similar system components to traverse from side to side of the enclosure structural shell 10. The at least one ceiling crossover joist 38 may be any length sufficient to span a distance between ceiling joists 36, for example between eight and thirty inches long. The ceiling crossover joist 38 includes a plurality of cross joist holes 32 that provide space for wires or lines to be installed through the ceiling crossover joist 38 with proper protection in all directions. The wiring holes 32 of the ceiling crossover joist 38 may be sized and shaped to accommodate utilities needed for a business of a user of the frame design. For example, the plurality of ceiling crossover joists 38 may include eight wiring holes 32, with four wiring holes 32 formed on each end of the ceiling crossover joist 38 starting two inches from a respective end of the ceiling crossover joist 38, each wiring hole 32 being one inch in diameter and spaced two inches apart from at least one other wiring hole 32 of the ceiling crossover joist 38. The ceiling crossover joist 38 thus allows for wires and lines to safely traverse from side to side in the frame design. For added protection of the wires or lines, a grommet 35, such as a rubber or plastic grommet, may be placed within each of the plurality of wiring holes 32.

At least one roof panel spans the length and width of the frame design and is configured to connect to at least one ceiling joist 30/36. The roof panel may be formed of any sufficiently strong and durable material that meets building codes safety requirements, such as steel tubing, c-channel, or any type of aluminum. The ceiling joists 30/36 are offset from the top of the frame design to allow for the flush installation of sub-roof material resulting in a strong and safe walk-on roof that allows for people to perform maintenance on equipment mounted on the roof. The offset of the ceiling joists 30/36 also allows for the proper installation of insulation to control heat transfer from the roof into the frame design.

A mechanical wall assembly 40 is also included in the enclosure structural shell 10. The mechanical wall assembly 40 may include both horizontal and vertical members of varying size, width, and thickness, that are arranged to extend from a mechanical base plate 13 of the base assembly 10 to the at least one roof panel. The mechanical base plate 13 may be supported by beams 17 with the base assembly 10. The particular arrangement of the mechanical wall assembly may be varied to meet the needs of the business or person using the frame design and their electrical requirements.

At least one wall angle 64 may be installed on the walls that rest on the base frame and get welded thereto.

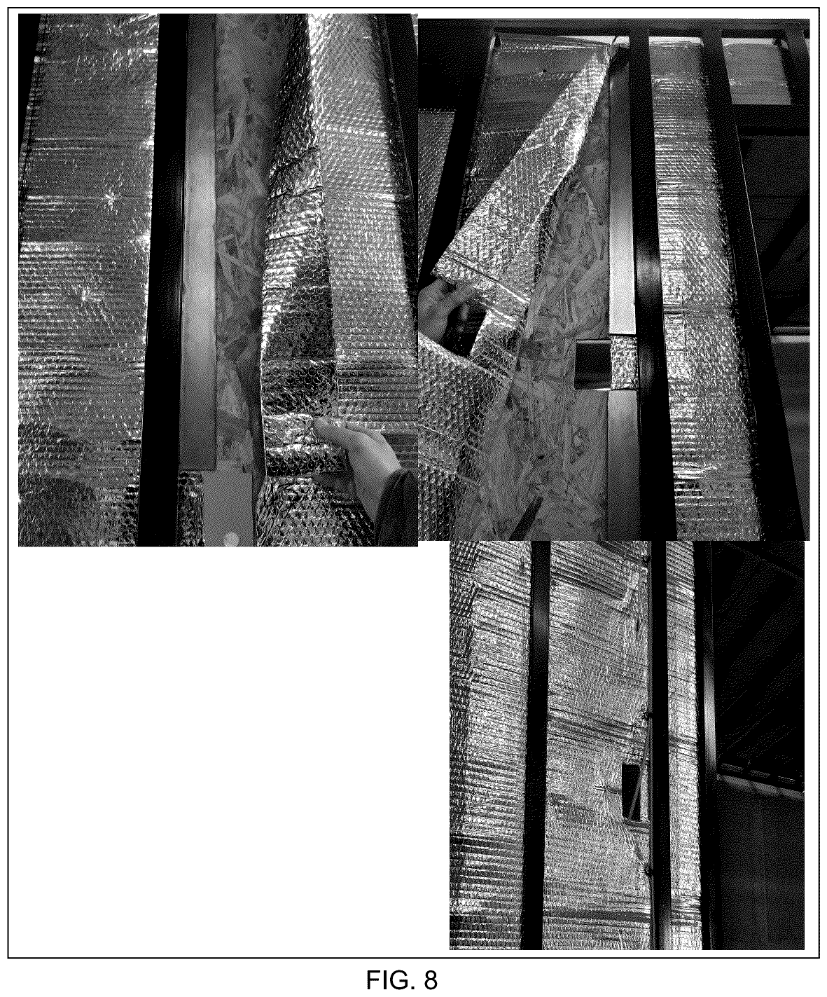

Referring to FIG. 8, the present invention may provide a protective barrier around wires and lines within the frame design. The protective barrier may be an angle or the like operatively associated together with other wall components to form the protective barrier. For example, the protective barrier may be substantially L-shaped and laced together with another element to form a substantially U-shaped barrier around wires and lines. An exemplary L-shaped wall angle may extend ¼ inch to ¾ inches for one leg of the L-shape and one inch to inches for the other leg of the L-shape, with a minimum thickness of ⅛ inch. Alternatively, an exemplary embodiment of the at least one protective barrier may be U-shaped and have an internal space at least ¾ inch in width and height to accommodate wires or lines. The at least one protective barrier may be formed of any suitably strong and durable material that meets building codes requirements, such as carbon or stainless steel.

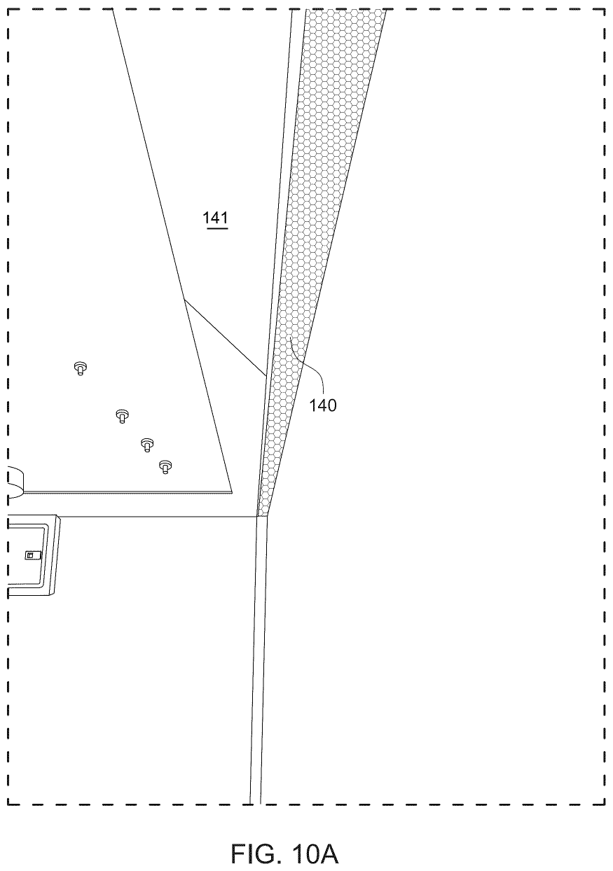

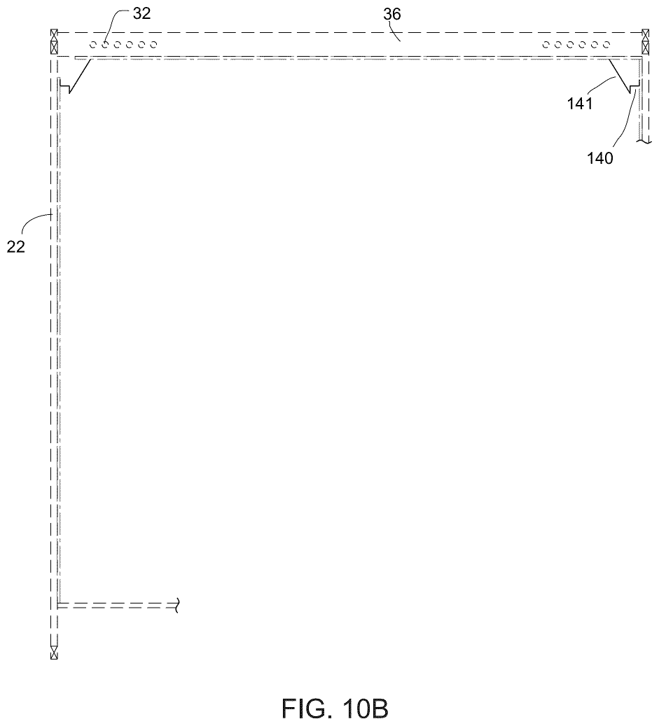

Referring to FIG. 10, the frame design may further include a trim tray vent along the interior space defined by the wall and ceiling assemblies, where they interface. The trim tray vent may be perforated to allow air to easily flow through the trim tray vent. The trim tray vent may have a flat or bent profile, such as a U, S, or Z-shaped profile. The trim tray vent may include a cross-sectional dimension of one inch by 1½ inches to allow sufficient airflow along the length of the trim tray vent.

The frame design further includes at least one floor plate 13 and at least one main beam 17. The at least one floor plate 13 extends a full width of the frame design and extends at least four inches beyond the mechanical wall assembly 40. Further, the at least one floor plate 13 may have a minimum thickness of ⅛ inches and be formed of a suitably strong and durable material that meets building code requirements, such as carbon steel or aluminum. The at least one main beam 17 may be a box beam that runs front to the back of the frame design. An exemplary main beam 17 may be 2×6 or 4×6 or 4×8 or 2×8 inches and have a wall thickness of ¼ inches. The main beam 17 may be formed of any suitably strong and tough material that meets building code requirements, such as steel.

The frame design may further include axle hangars 80 and axle hangar spacers 15. The axle hangars 17 are configured to connect to the main beam 16 and axles associated with the cargo trailer to which the frame design is retrofitted. The axle hangar spacers 58 are formed to create clearance for wires or lines to run under the frame design and up through the floor of the frame design in accordance with building code requirements, such as NFPA 54 and 58. Exemplary axle hangar spacers 15 may be formed as tubes that are 4 inches wide and 2 inches tall, with a wall thickness of ¼ inch so as to place the axle hangers 17 an additional 2 inches lower than the main frame and floor joists of the frame design. Further, the axle hangar spacers may be formed of suitably strong and durable materials that meet building code requirements, such as steel.

In an exemplary embodiment of the frame design, ceiling joists 30/36 are components of the roof system. The roof system may provide roof paneling 4 connected to the wall assemblies. There may be roof openings 5 for equipment. The ceiling joists 30 may carry lights 6 and hood assemblies 7. The ceiling crossover joists 38 may be placed a minimum of 8 inches apart and no greater than 24 inches apart across the entire width of the roof paneling 4 and may be placed in a vertical position to allow wires to run in a horizontal direction across the frame design.

Within this section of the roof paneling 4, the mechanical wall assembly 40 is installed according to a desired purpose of the user of the frame design. The mechanical wall assembly 40 can be arranged in a myriad of ways to accommodate a variety of trailer configurations, such as a flat front, v-nose front, modified v-nose, gooseneck, fifth wheel, bathroom in the front or utility room in the front with multiple doors, side ramp door, a double wall presentation, or even a front access door, among others. The mechanical wall assembly 40 is a minimum of eighteen inches wide to accommodate a standard flush mount main braker electric panel but may also be as wide as the full width of the frame design. If the mechanical wall assembly 40 does not transition across the entire width of the trailer it transitions back and connects to the front wall assembly. The section of the mechanical wall assembly 40 in which the electric panel is installed also has a ceiling crossover joist 38 installed above the electric panel location in a flat position to secure electrical wires that transition from running horizontally across the roof paneling 4 to running vertically into the electric panel. Within the mechanical wall assembly 40 and the side wall frame multiple vertical wall joists are placed to allow the electrical wires to transition from being run horizontally to vertically in a safe manner within the mechanical wall assembly 40.

In an exemplary embodiment of the frame design, a main power wire connection is on a front driver's side of the frame design and is located within a section of the wall encased by the mechanical wall assembly 40. The main connection is accomplished with the motor base plug base 14, e.g., a 50-amp motor base plug or a 4/5 wire cam-lock connection set. The motor base plug base 14 is installed into the motor base plate 9 and the main connection is run through the hole in the motor base plug base 14 and through the vertical wall joists 36 to a ceiling crossover joist 38 and then into the electric panel.

Each dedicated branch circuit wire can run the entire length of the frame design within the ceiling joists 30/36 to a ceiling crossover joist 38 set in the normal vertical position to the ceiling cross joist 38 set in a flat position before continuing into the main electrical panel. As the electrical wires transition from the ceiling joist 26 to the side wall frame and down to a designated receptacle, the electrical wires may be connected via wire clamps to vertical wall frame members and protected by the wall angles connected to the vertical wall frame members. This gives complete protection for the wires in all locations. Further, the trim tray vent allows air to freely flow up through wall cavities, the ceiling joists 36, and out of the trim tray, thus allowing hot air to escape the wall cavities and keep the electrical wiring cool.

The components of the frame design are created to allow for easy customization and rearrangement of the frame design to meet the needs of a user. Though the system is welded and should not be taken apart. The arrangement is decided and then built. The components can be added to existing units by welding to the frame for structural support. The frame design components can be realigned to facilitate the mechanical wall assembly 40 being placed in different positions within the frame design. This is welded and cannot be removed or added to once the size is set.

The frame design of the present invention thus allows for wires or lines to be run from any location within a retrofitted trailer in a safe and secure manner that satisfies building code requirements. The wires or lines are secure and properly separated to prevent puncture, rupture, cutting, overheating, electrical interference, and compression damage.

As used in this application, the term “about” or “approximately” refers to a range of values within plus or minus 10% of the specified number. And the term “substantially” refers to up to 80% or more of an entirety. Recitation of ranges of values herein are not intended to be limiting, referring instead individually to any and all values falling within the range, unless otherwise indicated, and each separate value within such a range is incorporated into the specification as if it were individually recited herein.

For purposes of this disclosure, the term “aligned” means parallel, substantially parallel, or forming an angle of less than 35.0 degrees. For purposes of this disclosure, the term “transverse” means perpendicular, substantially perpendicular, or forming an angle between 55.0 and 125.0 degrees. Also, for purposes of this disclosure, the term “length” means the longest dimension of an object. Also, for purposes of this disclosure, the term “width” means the dimension of an object from side to side. For the purposes of this disclosure, the term “above” generally means superjacent, substantially superjacent, or higher than another object although not directly overlying the object. Further, for purposes of this disclosure, the term “mechanical communication” generally refers to components being in direct physical contact with each other or being in indirect physical contact with each other where movement of one component affect the position of the other.

The use of any and all examples, or exemplary language (“e.g.,” “such as,” or the like) provided herein, is intended merely to better illuminate the embodiments and does not pose a limitation on the scope of the embodiments or the claims. No language in the specification should be construed as indicating any unclaimed element as essential to the practice of the disclosed embodiments.

In the following description, it is understood that terms such as “first,” “second,” “top,” “bottom,” “up,” “down,” and the like, are words of convenience and are not to be construed as limiting terms unless specifically stated to the contrary.

It should be understood, of course, that the foregoing relates to exemplary embodiments of the invention and that modifications may be made without departing from the spirit and scope of the invention as set forth in the following claims.

What is claimed is:

1. A system for an enclosed mobile commercial structure, the system comprising:
a base frame;
a wall assembly along a substantial portion of a periphery of the base frame so as to define the enclosed mobile commercial structure, wherein one or more of a plurality of wall wiring joists of the wall assembly circumscribing a plurality of wiring holes, wherein each wiring hole is dimensioned and shaped to carry electrically wiring from an electrical source external to the enclosed mobile commercial structure and an electrical panel within an interior of the enclosed mobile commercial structure; and
a ceiling assembly extends between an upper portion of the wall assembly.

2. The system of claim 1, wherein each wiring hole is at least one-and-a-half inch from an adjacent wiring hole, and wherein each wiring hole is at least one-and-three-quarters inch from an edge of the wiring joist.

3. The system of claim 2, wherein one or more of a plurality of ceiling wiring joists of the ceiling assembly circumscribing a plurality of said wiring holes so that the electrically wiring can be carried from the wall assembly and through the ceiling assembly.

4. The system of claim 3, further comprising a mechanical wall assembly offset from the wall assembly, wherein said electrical wiring directly connects to the mechanical wall assembly by way of the ceiling assembly.

5. The system of claim 4, wherein the mechanical wall assembly houses the electrical panel.

6. The system of claim 5, wherein the mechanical wall assembly is at least eighteen inches in width.

7. The system of claim 6, wherein the plurality of ceiling wiring joists comprises a plurality of ceiling wiring joists and a plurality of crossover wiring joists, wherein the plurality of ceiling wiring joists provides wiring holes oriented lengthwise relative to the enclosed mobile commercial structure, and wherein the plurality of crossover wiring joists provide wiring holes oriented widthwise relative to the enclosed mobile commercial structure so that the electrical wiring traverses the enclosed mobile commercial structure lengthwise and makes turn to traverse the enclosed mobile commercial structure widthwise, respectively.

8. The system of claim 7, wherein at least one wiring hole has a grommet is operatively associated therewith.

9. The system of claim 8, further compromising two attachment points along the wall assembly for accommodating an exterior installation of a fuel tank rack.

10. The system of claim 9, further comprising a trim tray along said interior adjacent an interface of the wall assembly and the ceiling assembly, wherein the trim tray is configured to provide passive air flow for cooling and a source of makeup air of an exhaust system for the enclosed mobile commercial structure.

11. The system of claim 10, further comprising a center tube extending from an apex of an A-frame of the base frame for a distance approximately equal to one-third of a length of the base frame, wherein the center tube is configured for placement of equipment and loading throughout the base frame.

12. The system of claim 11, further comprising a plurality of gas line hangers connected along an underside of the base frame, wherein each gas line hanger has a gas line engager disposed approximately four inches below the underside of the base frame.

13. The system of claim 12, further comprising a plurality of gas line hanger connected along an underside of the base frame, wherein each gas line hanger has a gas line engager disposed a predetermined clearance above an axle operatively associated with the enclosed mobile commercial structure.

14. The system of claim 13, wherein the predetermined clearance is approximately four inches.

15. The system of claim 14, further comprising an offset member between an axle hanger operatively associated with said axle and the underside of the base frame to further maintain the predetermined clearance.
